(19) United States
(12) Patent Application Publication
(10) Pub. No.: US 2024/0430790 A1
(43) Pub. Date: Dec. 26, 2024

(54) NETWORK DETERMINING METHOD, NETWORK ACCESS METHOD, DATA TRANSMISSION METHOD, AND RELATED DEVICE

(71) Applicant: VIVO MOBILE COMMUNICATION CO., LTD., Guangdong (CN)

(72) Inventors: Lufeng HAN, Guangdong (CN); Xiaodong SUN, Guangdong (CN)

(21) Appl. No.: 18/830,812

(22) Filed: Sep. 11, 2024

Related U.S. Application Data
(63) Continuation of application No. PCT/CN2023/080012, filed on Mar. 7, 2023.

(30) Foreign Application Priority Data
Mar. 11, 2022 (CN) 202210238539.5

(51) Int. Cl. H04W 48/18; H04W 64/00; H04W 84/06

(52) U.S. Cl. CPC H04W 48/18; H04W 64/003; H04W 84/06

(57) ABSTRACT

This application pertains to the field of communication technologies, and discloses a network determining method, a network access method, a data transmission method, and a related device. The network determining method in embodiments of this application includes: determining, by a terminal, coverage information of each of at least two networks, where the coverage information is used to indicate a duration in which the network covers the terminal; and executing, by the terminal, a first operation based on the coverage information, where the first operation includes at least one of the following: selecting a first target network from the at least two networks; and determining a priority of each of the at least two networks.

### CROSS-REFERENCE TO RELATED APPLICATIONS

This application is a Bypass Continuation application of PCT International Application No. PCT/CN2023/080012 filed on Mar. 7, 2023, which claims priority to Chinese Patent Application No. 202210238539.5, filed in China on Mar. 11, 2022, which are incorporated herein by reference in their entireties.

### TECHNICAL FIELD

This application pertains to the field of communication technologies, and specifically relates to a network determining method, a network access method, a data transmission method, and a related device.

### BACKGROUND

When a terminal selects a satellite network, the terminal may select a network with a high priority and high signal quality, but the network may not cover the terminal soon due to satellite movement or other reasons. If the terminal selects this network, the terminal will soon lose coverage, which may lead to a signaling or service interruption and affect communication performance between the terminal and a network-side device.

### SUMMARY

According to a first aspect, a network determining method is provided. The method includes:

determining, by a terminal, coverage information of each of at least two networks, where the coverage information is used to indicate a duration in which the network covers the terminal; and

executing, by the terminal, a first operation based on the coverage information, where the first operation includes at least one of the following:

selecting a first target network from the at least two networks; and

determining a priority of each of the at least two networks.

According to a second aspect, a network determining apparatus is provided. The apparatus includes:

a first determining module, configured to determine coverage information of each of at least two networks, where the coverage information is used to indicate a time when the network covers a terminal; and

an execution module, configured to execute a first operation based on the coverage information, where the first operation includes at least one of the following:

selecting a first target network from the at least two networks; and

determining a priority of each of the at least two networks.

According to a third aspect, a network access method is provided. The method includes:

in a case that a terminal is not covered by a second target network, determining, by the terminal, a second target time when the second target network covers the terminal;

determining, by the terminal, a second access time based on the second target time; and

accessing, by the terminal, the second target network based on the second access time.

According to a fourth aspect, a network access apparatus is provided. The apparatus includes:

a first determining module, configured to determine, in a case that a terminal is not covered by a second target network, a second target time when the second target network covers the terminal;

a second determining module, configured to determine a second access time based on the second target time; and

an access module, configured to access the second target network based on the second access time.

According to a fifth aspect, a data transmission method is provided. The method includes:

in a case that a network-side device is in a connected state with a terminal, determining, by the network-side device, a target duration in which a network of the network-side device continues to cover the terminal; and

determining, by the network-side device based on the target duration and an execution duration of a target operation, whether the network-side device executes the target operation, where the target operation is an operation related to data transmission.

According to a sixth aspect, a data transmission apparatus is provided. The apparatus includes:

a first determining module, configured to determine, in a case that a network-side device is in a connected state with a terminal, a target duration in which a network of the network-side device continues to cover the terminal; and

a second determining module, configured to determine, based on the target duration and an execution duration of a target operation, whether the network-side device executes the target operation, where the target operation is an operation related to data transmission.

According to a seventh aspect, a terminal is provided. The terminal includes a processor and a memory. The memory is configured to store a program or instructions capable of running on the processor. When the program or instructions are executed by the processor, the steps of the method according to the first aspect or the third aspect are implemented.

According to an eighth aspect, a terminal is provided and includes a processor and a communication interface. The processor is configured to determine coverage information of each of at least two networks, and execute a first operation based on the coverage information, where the first operation includes at least one of the following: selecting a first target network from the at least two networks; and determining a priority of each of the at least two networks, where the coverage information is used to indicate a duration in which the network covers the terminal.

According to a ninth aspect, a terminal is provided and includes a processor and a communication interface. The processor is configured to: in a case that a terminal is not covered by a second target network, determine a second target time when the second target network covers the terminal; determine a second access time based on the second target time; and access the second target network based on the second access time.

According to a tenth aspect, a network-side device is provided. The network-side device includes a processor and a memory. The memory is configured to store a program or instructions capable of running on the processor. When the program or instructions are executed by the processor, the steps of the method according to the fifth aspect are implemented.

According to an eleventh aspect, a network-side device is provided and includes a processor and a communication interface. The processor is configured to: in a case that a network-side device is in a connected state with a terminal, determine a target duration in which a network of the network-side device continues to cover the terminal; and determine, based on the target duration and an execution duration of a target operation, whether the network-side device executes the target operation, where the target operation is an operation related to data transmission.

According to a twelfth aspect, a communication system is provided and includes a terminal and a network-side device. The terminal may be configured to perform the steps of the network determining method according to the first aspect.

According to a thirteenth aspect, a communication system is provided and includes a terminal and a network-side device. The terminal may be configured to perform the steps of the network access method according to the third aspect.

According to a fourteenth aspect, a communication system is provided and includes a terminal and a network-side device. The network-side device may be configured to perform the steps of the data transmission method according to the fifth aspect.

According to a fifteenth aspect, a readable storage medium is provided, where a program or instructions are stored in the readable storage medium, and when the program or instructions are executed by a processor, the steps of the method according to the first aspect, the third aspect, or the fifth aspect are implemented.

According to a sixteenth aspect, a chip is provided. The chip includes a processor and a communication interface. The communication interface is coupled to the processor. The processor is configured to run a program or instructions to implement the steps of the method according to the first aspect, the third aspect, or the fifth aspect.

According to a seventh aspect, a computer program or program product is provided. The computer program or program product is stored in a storage medium. The computer program or program product is executed by at least one processor to implement the steps of the method according to the first aspect, the third aspect, or the fifth aspect.

### BRIEF DESCRIPTION OF DRAWINGS

FIG. 1 is a block diagram of a wireless communication system to which an embodiment of this application may be applied;

FIG. 2 is a first flowchart of a network determining method according to an embodiment of this application;

FIG. 3 is a second flowchart of a network determining method according to an embodiment of this application;

FIG. 4 is a third flowchart of a network determining method according to an embodiment of this application;

FIG. 5a is a first flowchart of interaction between UE and a network-side device according to an embodiment of this application;

FIG. 5b is a second flowchart of interaction between UE and a network-side device according to an embodiment of this application;

FIG. 5c is a third flowchart of interaction between UE and a network-side device according to an embodiment of this application;

FIG. 6 is a first structural diagram of a network determining apparatus according to an embodiment of this application;

FIG. 7 is a second structural diagram of a network determining apparatus according to an embodiment of this application;

FIG. 8 is a third structural diagram of a network determining apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network-side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a long term evolution (LTE)/LTE-Advanced (LTE-A) system, and can also be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other applications than an NR system application, for example, a 6th Generation (6G) communication system.

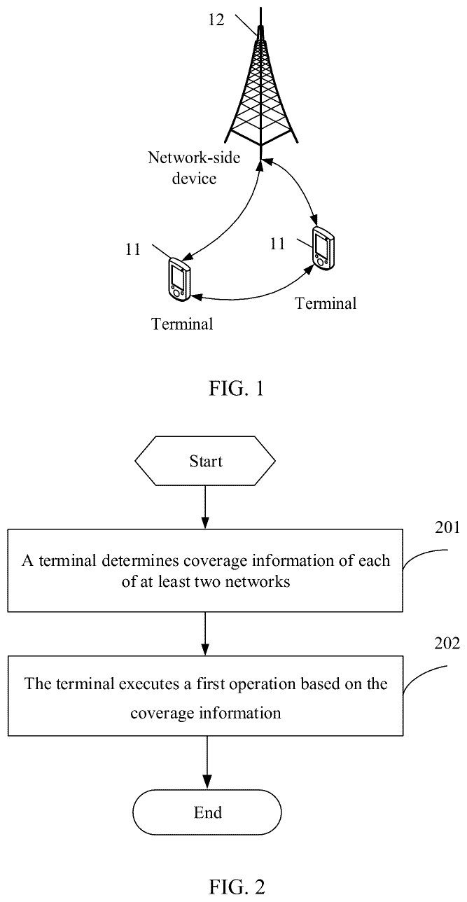

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network element. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. As long as the same technical effects are achieved, the base station is not limited to specific technical terms. It should be noted that in the embodiments of this application, only a base station in an NR system is used as an example for description, but a specific type of the base station is not limited.

A method provided in the embodiments of this application is hereinafter described in detail by using some embodiments and application scenarios thereof with reference to the accompanying drawings.

As shown in FIG. 2, an embodiment of this application provides a network determining method. The method includes the following steps.

Step 201: A terminal determines coverage information of each of at least two networks, where the coverage information is used to indicate a duration in which the network covers the terminal.

The terminal discovers the at least two networks, for example, discovers the at least two networks through a network search process. The terminal obtains the coverage information of each network. The coverage information may include at least one of a coverage duration and a coverage time interval in which each of the at least two networks covers the terminal. The coverage duration is duration in which the network continues to cover the terminal, and the coverage time interval is a time interval in which the network continues to cover the terminal. The terminal may determine the coverage information of the network based on ephemeris information or by using analytics of a network data analytics function (NWDAF).

The coverage duration may be understood as duration in which the terminal is located in a coverage area of the network. Generally, if the coverage area of the network is larger, the coverage duration may be considered as longer. Further, a moving route of the terminal may be compared with the coverage area of the network, and the coverage duration is determined based on a duration in which the moving route falls within the coverage area of the network.

Each of the at least two networks in this application may be a satellite network. In addition, the at least two networks may include both a satellite network and a non-satellite network. An example of the non-satellite network is a terrestrial network.

Step 202: The terminal executes a first operation based on the coverage information, where the first operation includes at least one of the following:

selecting a first target network from the at least two networks; and

determining a priority of each of the at least two networks.

The terminal may select, based on the coverage information, one network from the at least two networks as the first target network for access; or determine the priority of each network, for example, the longer the coverage duration, the higher the priority; or after determining the priority of each network, select a network with a highest priority as the first target network for access.

In this embodiment, the terminal determines the coverage information of each of the at least two networks; and the terminal executes the first operation based on the coverage information, where the first operation includes at least one of the following: selecting the first target network from the at least two networks; and determining the priority of each of the at least two networks. Through the foregoing process, the terminal may determine a most suitable network from the at least two networks for access. Therefore, a network coverage effect is effectively ensured, and communication performance between the terminal and a network-side device is improved.

In an embodiment of this application, that a terminal determines coverage information of each of at least two networks includes:

the terminal obtains ephemeris information of each of the at least two networks; and

the terminal determines the coverage information of each of the at least two networks based on the ephemeris information of each of the at least two networks.

In this embodiment, the terminal determines the coverage information of the network based on the ephemeris information of the network. The ephemeris information includes at least one of the following: satellite orbit information, satellite location information, and satellite speed information.

The terminal may obtain the ephemeris information of the network by receiving broadcast information or network signaling carrying the ephemeris information, for example, radio resource control (RRC) signaling or network attached storage (NAS) signaling. Alternatively, the terminal may obtain the ephemeris information of the network locally. For example, the ephemeris information is preconfigured in the terminal. The ephemeris information may be configured in a universal subscriber identity module (USIM) or mobile equipment (ME).

In an embodiment of this application, the selecting a first target network from the at least two networks includes:

selecting a network with the longest coverage duration from the at least two networks as the first target network;

or

selecting a network with a highest matching degree between the coverage time interval and a service connection time of the terminal from the at least two networks as the first target network.

The service connection time includes at least one of the following:

a time required by the network search process;

an active time of the terminal;

a time required for establishing a connection;

a time required for transmitting uplink data; and

a time required for transmitting downlink data.

The active time of the terminal means that when the terminal enters an idle state, an authentication management function (AMF) starts an active timer, during running of which the AMF can page the UE, and a running time of the active timer is the active time of the terminal.

In the foregoing description, when selecting the first target network, the terminal may select the network with the longest coverage duration from the at least two networks as the first target network, or select the network with the highest matching degree between the coverage time interval and the service connection time of the terminal from the at least two networks as the first target network.

The matching degree between the coverage time interval and the service connection time of the terminal may be that the coverage time interval is suitable for the service connection time of the UE. For example, when the terminal has a service connection, the terminal is covered by the network, or when the terminal has no service connection, the terminal is not covered by the network. Further, when the terminal has a service connection, the longer the coverage duration of the network, the higher the matching degree of the network.

In an embodiment of this application, the determining a priority of each of the at least two networks includes:

in a case that a coverage duration of a first network is longer than a coverage duration of a second network, determining that a priority of the first network is higher than a priority of the second network;

or

in a case that a matching degree between a coverage time interval of a first network and a service connection time of the terminal is higher than a matching degree between a coverage time interval of a second network and the service connection time of the terminal, determining that a priority of the first network is higher than a priority of the second network, where

the first network and the second network are any two of the at least two networks.

Specifically, the coverage duration may be understood as the duration in which the terminal is located in the coverage area of the network. Generally, if the coverage area of the network is larger, the coverage duration may be considered as longer. Further, the moving route of the terminal may be compared with the coverage area of the network, and the coverage duration is determined based on the duration in which the moving route falls within the coverage area of the network. The longer the coverage duration, the higher the priority.

The matching degree between the coverage time interval and the service connection time of the terminal may be that the coverage time interval is suitable for the service connection time of the UE. For example, when the terminal has a service connection, the terminal is covered by the network, or when the terminal has no service connection, the terminal is not covered by the network, and it is determined that the matching degree of the network is the highest. Further, when the terminal has a service connection, the longer the coverage duration of the network, the higher the matching degree of the network. The higher the matching degree of the network, the higher the priority.

In an embodiment of this application, after the selecting a first target network from the at least two networks, the method further includes:

the terminal determines a first duration in which the first target network continues to cover the terminal; and

the terminal determines, based on the first duration and an execution duration of a second operation, whether the terminal executes the second operation, where the second operation is an operation related to data transmission.

Specifically, after the terminal selects the first target network, the terminal accesses the first target network, and transmits and receives data through the first target network. When the terminal has data (such as signaling or user plane data) to send, the terminal may first determine the first duration in which the first target network continues to cover the terminal, for example, determine the first duration based on ephemeris information of the first target network, and determine, based on the first duration and the execution duration of the second operation, whether the terminal executes the second operation.

The second operation is an operation related to data transmission, such as sending data, or executing a procedure related to sending signaling. In other words, the second operation includes sending data or transmitting signaling. For example, if the second operation is sending data, the execution duration of the second operation may be understood as duration required to complete sending of the data; or if the second operation is executing a signaling procedure, the execution duration of the second operation may be understood as duration required to complete the entire signaling procedure.

In the foregoing description, in one case, that the terminal determines, based on the first duration and an execution duration of a second operation, whether the terminal executes the second operation includes:

the terminal executes the second operation in a case that the first duration is longer than or equal to the execution duration of the second operation.

If the first duration is longer than or equal to the execution duration of the second operation, it means that the first duration can support data transmission, and the terminal executes the second operation, for example, the terminal sends data. Further, after receiving the data, the network-side device sends response data to the terminal to confirm reception of the data or respond to received signaling.

In another case, that the terminal determines, based on the first duration and an execution duration of a second operation, whether the terminal executes the second operation includes:

the terminal executes one of the following in a case that the first duration is shorter than the execution duration of the second operation:

buffering data related to the second operation;

suspending a procedure related to the second operation;

terminating the procedure related to the second operation; and

sending a first request for increasing a transmission bandwidth to a first target network device, where the first request carries the first duration.

Specifically, if the first duration is not enough to support data transmission, the data is not sent, and the data may be buffered, or the procedure may be suspended, or the procedure may be terminated, or the first request may be sent to the first target network device to request to increase the transmission bandwidth. The first target network device may be a session management function (SMF). Further, the first target network device may adjust the transmission bandwidth between the terminal and the network-side device based on the first duration. The shorter the first duration, the larger the adjusted transmission bandwidth.

In an embodiment of this application, after the terminal sends the first request for increasing the transmission bandwidth to the first target network device, the method further includes:

the terminal transmits the data related to the second operation based on a target bandwidth, where the target bandwidth is a bandwidth determined based on the first request, and a time required for the terminal to transmit the data related to the second operation based on the target bandwidth is shorter than the first duration.

Because the transmission bandwidth is increased and the target bandwidth is used to transmit the data related to the second operation, the execution of the second operation can be completed before the terminal loses coverage of the first target network soon, thereby avoiding impact on the data transmission related to the second operation and improving communication performance.

In an embodiment of this application, after the selecting a first target network from the at least two networks, the method further includes:

in a case that the first target network does not cover the terminal, the terminal determines a first target time when the first target network covers the terminal again;

the terminal determines a first access time based on the first target time; and

the terminal accesses the first target network based on the first access time.

Specifically, after the terminal selects the first target network, the terminal accesses the first target network, and transmits and receives data through the first target network. Due to satellite movement or terminal movement, the terminal may not be within the coverage of the first target network. In the case that the first target network does not cover the terminal, the terminal determines the first target time when the first target network covers the terminal again, and determines the first access time based on the first target time. For example, if the first target time is 13:15, the terminal may determine that the first access time is 13:15 or 13:16, and performs access at the first access time.

Preferably, the terminal delays for a first preset time based on the first target time to obtain the first access time. Because a plurality of terminals may access the first target network, each terminal may perform access after delaying for the first preset time after the first target time is determined. Because the first preset time selected by different terminals may vary, the determined first access time may also vary. Therefore, congestion caused by simultaneous access to the first target network by the plurality of terminals can be effectively avoided.

In the foregoing description, the first preset time includes one of the following:
(1) a random value, where the random value may have a maximum value and a minimum value;
(2) a time interval value, where the interval value includes a maximum value and a minimum value;
(3) a value preconfigured in the terminal, for example, a value configured in the USIM or ME of the terminal;
(4) a value received by the terminal, for example, a value sent by the network-side device and received by the terminal;
(5) a value determined based on received signaling, for example, a value determined based on NAS signaling, including a registration message, a terminal configuration update (UE Configuration Update, UCU) message, or a NAS transport message, or a value determined based on RRC signaling, for example, a reconfiguration message;
(6) a value sent by the network-side device to the terminal by using RRC signaling or NAS signaling; and
(7) a value obtained through calculation based on a terminal identity.

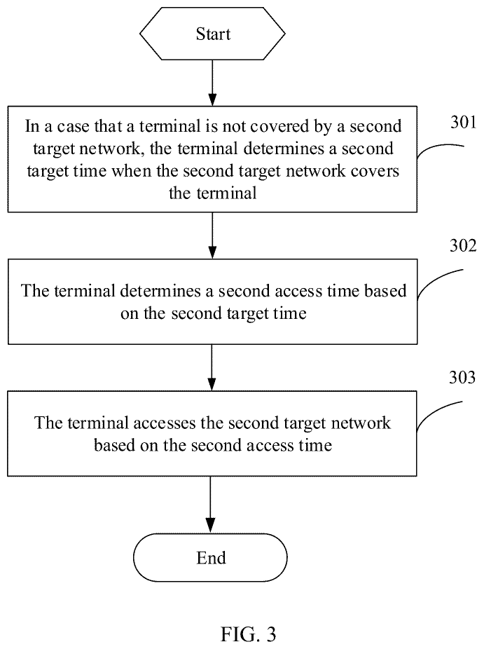

As shown in FIG. 3, an embodiment of this application provides a network access method. The method includes the following steps.

Step 301: In a case that a terminal is not covered by a second target network, the terminal determines a second target time when the second target network covers the terminal.

An application scenario of this embodiment may be: the terminal accesses the second target network, but the terminal is not within coverage of the second target network due to satellite movement or terminal movement, and in this case, the terminal determines the second target time when the second target network covers the terminal again. Alternatively, the terminal does not access the second target network, and the terminal determines the second target time when the second target network covers the terminal.

In the foregoing description, if the terminal accesses the second target network, the terminal may access the second target network in a mode in the foregoing network determining method, or the terminal may access the second target network in other modes. This is not limited herein.

Step 302: The terminal determines a second access time based on the second target time.

The terminal determines the second target time when the second target network covers the terminal, and determines the second access time based on the second target time. For example, if the second target time is 13:15, the terminal may determine that the second access time is 13:15 or 13:16.

Step 303: The terminal accesses the second target network based on the second access time.

In this embodiment, in the case that the terminal is not covered by the second target network, the terminal determines the second target time when the second target network covers the terminal; the terminal determines the second access time based on the second target time; and the terminal accesses the second target network based on the second access time. Because a plurality of terminals may access the second target network, each terminal may perform access after delaying for a second preset time after the second target time is determined. Because the second preset time selected by different terminals may vary, the determined second access time may also vary. Therefore, congestion caused by simultaneous access to the second target network by the plurality of terminals can be effectively avoided.

In the foregoing description, that the terminal determines a second access time based on the second target time includes:

the terminal delays for the second preset time based on the second target time to obtain the second access time. The second preset time includes one of the following:
(1) a random value, where the random value may have a maximum value and a minimum value;
(2) a time interval value, where the interval value includes a maximum value and a minimum value;
(3) a value preconfigured in the terminal, for example, a value configured in a USIM or ME of the terminal;
(4) a value received by the terminal, for example, a value sent by a network-side device and received by the terminal;
(5) a value determined based on received signaling, for example, a value determined based on NAS signaling, including a registration message, a UCU message, or a NAS transport message, or a value determined based on RRC signaling, for example, a reconfiguration message;
(6) a value sent by the network-side device to the terminal by using RRC signaling or NAS signaling; and
(7) a value obtained through calculation based on a terminal identity.

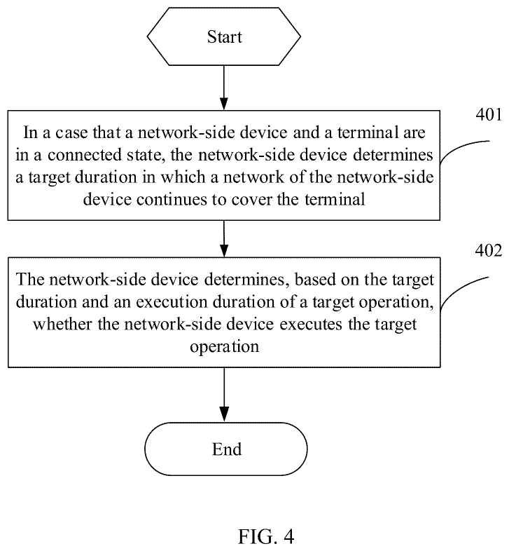

As shown in FIG. 4, an embodiment of this application provides a data transmission method. The method includes the following steps.

Step 401: In a case that a network-side device is in a connected state with a terminal, the network-side device determines a target duration in which a network of the network-side device continues to cover the terminal.

Specifically, in the case that the network-side device and the terminal are in the connected state, when the network-side device has data (such as signaling or user plane data) to send, the target duration in which the network of the network-side device continues to cover the terminal may be determined first. For example, the target duration is determined based on ephemeris information of the network of the network-side device. The ephemeris information includes at least one of the following: satellite orbit information, satellite location information, and satellite speed information.

Step 402: The network-side device determines, based on the target duration and an execution duration of a target operation, whether the network-side device executes the target operation, where the target operation is an operation related to data transmission, such as sending data, or executing a procedure related to sending signaling. In other words, the target operation includes sending data or transmitting signaling. For example, if the target operation is sending data, the execution duration of the target operation may be understood as duration required to complete sending of the data; or if the target operation is executing a signaling procedure, the execution duration of the target operation may be understood as duration required to complete the entire signaling procedure.

The network-side device may be a device that communicates with the terminal, for example, may be an AMF, an SMF, a UPF, or a gNB.

In this embodiment, in the case that the network-side device and the terminal are in the connected state, the network-side device determines the target duration in which the network of the network-side device continues to cover the terminal; and the network-side device determines, based on the target duration and the execution duration of the target operation, whether the network-side device executes the target operation, where the target operation is the operation related to data transmission. A disadvantage that the target operation of the network-side device is not completed in a process of the terminal from being covered by the network to not being covered by the network, resulting in a data loss or failure to complete a signaling procedure in time, can be effectively avoided by using the foregoing method.

In an embodiment of this application, that the network-side device determines, based on the target duration and an execution duration of a target operation, whether the network-side device executes the target operation includes:

the network-side device executes the target operation in a case that the target duration is longer than or equal to the execution duration of the target operation.

If the target duration is longer than or equal to the execution duration of the target operation, it means that the target duration can support data transmission, and the network-side device executes the target operation, for example, sends data. Further, after receiving the data, the terminal sends response data to the network-side device to confirm reception of the data or respond to received signaling.

In an embodiment of this application, that the network-side device determines, based on the target duration and an execution duration of a target operation, whether the network-side device executes the target operation includes:

the network-side device executes one of the following in a case that the target duration is shorter than the execution duration of the target operation:

buffering data related to the target operation;

suspending a procedure related to the target operation;

terminating the procedure related to the target operation;

sending a second request for increasing a transmission bandwidth to a first target network device, where the second request carries the target duration; and

adjusting a current transmission bandwidth of the network.

Specifically, if the target duration is not enough to support data transmission, the data is not sent, and the data may be buffered, or the procedure may be suspended, or the procedure may be terminated, or the second request may be sent to the first target network device to request to increase the transmission bandwidth. The first target network device may be an SMF. Further, the first target network device may adjust the transmission bandwidth between the terminal and the network-side device based on the target duration. The shorter the target duration, the larger the adjusted transmission bandwidth. The first target network device adjusts the transmission bandwidth between the network-side device and the terminal to a first target bandwidth based on the second request, and the network-side device transmits the data related to the target operation based on the first target bandwidth, where the first target bandwidth is a bandwidth determined based on the second request, and a time required for the network-side device to transmit the data related to the target operation based on the first target bandwidth is shorter than the target duration.

The network-side device may not only request the first target network device to increase the transmission bandwidth, but also adjust the current transmission bandwidth. The adjusting the current transmission bandwidth includes:

the network-side device determines, based on a pre-obtained mapping relationship, a second target bandwidth corresponding to the target duration, where the mapping relationship includes a correspondence between duration and a bandwidth.

Specifically, the mapping relationship may be configured by a second target network device, and the second target network may be a RAN. The second target network device may push one group of correspondences or a plurality of groups of correspondences to the network-side device, for example, a correspondence between a first duration and a first bandwidth and a correspondence between a second duration and a second bandwidth, where the shorter the duration, the larger the bandwidth. A parameter of the bandwidth in the mapping relationship includes at least one of the following:

an aggregate maximum bit rate (AMBR);

an uplink (UL) maximum flow bit rate (MFBR); and

a downlink (DL) MFBR.

After the adjusting the current transmission bandwidth, the method further includes:

the network-side device transmits the data related to the target operation based on the second target bandwidth, where a time required for the network-side device to transmit the data related to the target operation based on the second target bandwidth is shorter than the target duration.

The method provided in this application is hereinafter described by using examples.

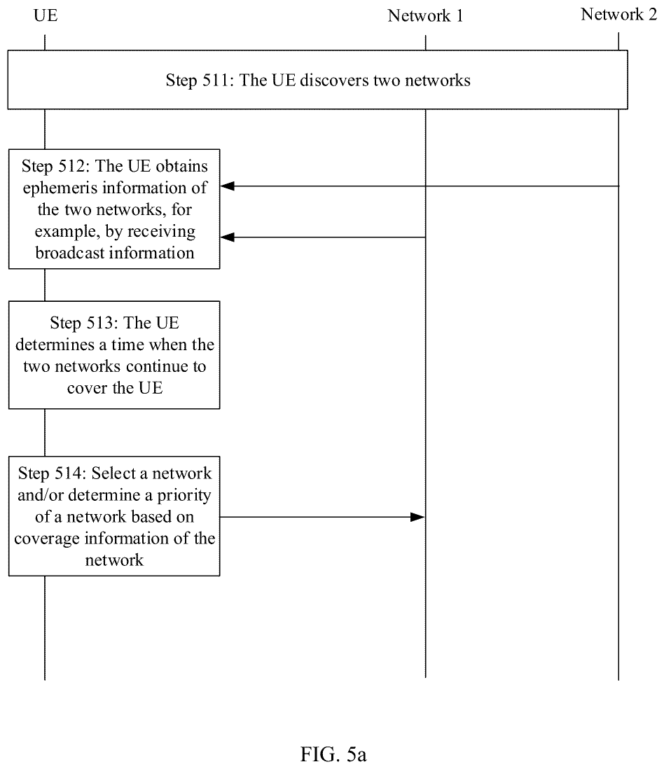

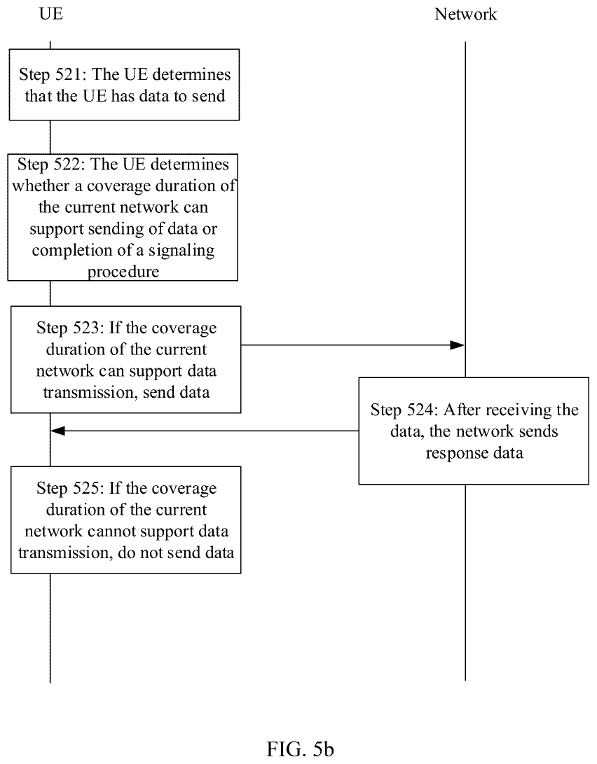

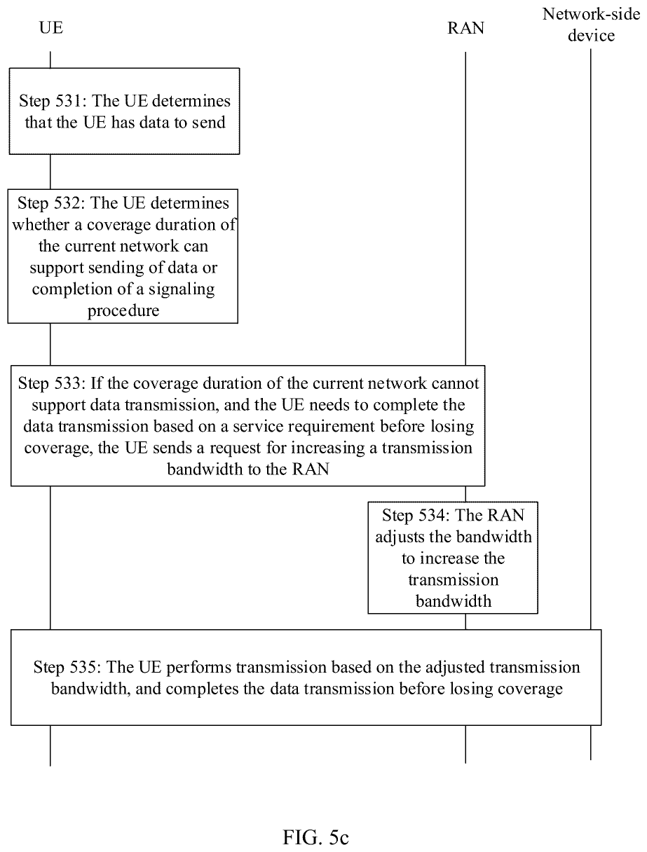

FIG. 5a is a schematic diagram of interaction between UE and a network, where the UE selects a network based on coverage information of the network.

Step 511: The UE discovers two networks: network 1 and network 2, and the UE may discover the networks through a network search process.

Step 512: The UE obtains ephemeris information of the two networks, for example, may receive the ephemeris information of the two networks, and obtain the ephemeris information by receiving broadcast information (the broadcast information carries the ephemeris information) or network signaling (the signaling carries the ephemeris information), such as RRC signaling or NAS signaling; or the UE obtains ephemeris information of the two networks locally, for example, ephemeris information configured in a USIM or ME of the UE.

Step 513: The UE determines a time when the two networks continue to cover the UE, for example, determines the time by using the ephemeris information, or by using analytics of an NWDAF, such as statistical or predictive information.

Step 514: Select a network or determine a priority of a network based on coverage information of the network.

For example, in terms of coverage duration, the UE preferentially selects a network with a longer coverage duration and/or determines that the network has a higher priority; for a network with a shorter coverage duration, the UE determines that the network has a lower priority; or the UE selects a network with a coverage duration suitable for a service connection time of the UE.

For example, in terms of coverage, it is determined that a network with wider coverage has a higher priority; for a network with narrower coverage, it is determined that the network has a lower priority; or for a network whose coverage is more suitable for location and/or time information of the UE, such as a moving route (for example, travel information of the UE), it is determined that the network has a higher priority.

For example, if a coverage duration of network 1 meets a requirement of the UE better, for example, if the UE is in a coverage area for a long time, when the UE selects a network, the UE preferentially selects network 1, or may increase a priority of network 1, and may subsequently initiate access.

If a coverage duration of network 2 does not meet the requirement of the UE, for example, if the coverage duration is short and the UE soon loses coverage, when the UE selects a network, the UE preferentially selects another network, or may reduce a priority of network 2.

In the foregoing description, the UE selects a network that can cover the UE for a long time, which can reduce network switching and improve service experience.

FIG. 5b is a schematic diagram of interaction between UE and a network, where the UE performs data transmission based on coverage information of the network.

Step 521: The UE determines that the UE has data to send, including signaling or user plane data.

Step 522: The UE determines whether a coverage duration of a current network can support sending of data or completion of a signaling procedure. A time required by the signaling procedure is determined. For example, each signaling sending procedure corresponds to a sending time, or a default sending time may be used, or the time may be estimated based on network conditions such as signal conditions.

The UE can obtain or use ephemeris information of two networks, for example, can receive the ephemeris information of the two networks, for example, obtain the ephemeris information by receiving broadcast information, or network signaling, such as RRC signaling or NAS signaling; or ephemeris information of the two networks locally available in the UE, for example, configured in the UE, for example, in a USIM or ME.

The UE determines the time when the two networks continue to cover the UE, for example, determines the time by using the ephemeris information or based on analytics of an NWDAF, such as statistical or predictive data.

Step 523: If the coverage duration of the current network can support data transmission, send data.

Step 524: After receiving the data, the network sends response data, for example, confirms reception of the data or responds to received signaling.

Step 525: If the coverage duration of the current network cannot support data transmission, do not send data, for example, buffer the data, suspend the procedure, or terminate the procedure.

In the foregoing description, positions of the UE and the network may be interchanged, that is, the network-side device may also perform data transmission based on network coverage information. For details, refer to content described in the method embodiment shown in FIG. 4. Details are not described herein again.

In the foregoing description, the network refers to a network of devices such as an access and mobility management function (AMF), an SMF, a user plane function (UPF), and a gNB, that can communicate with the UE.

In this way, for data transmission or a signaling procedure with a high probability of failure, by suspending or terminating the data transmission or signaling procedure, a network resource waste caused by the failed procedure is reduced.

FIG. 5c is a schematic diagram of interaction between UE and a network, where the UE performs data transmission based on coverage information of the network.

Step 531: The UE determines that the UE has data to send, including signaling or user plane data.

Step 532: The UE determines whether a coverage duration of a current network can support sending of data or completion of a signaling procedure. A time required by the signaling procedure is determined. For example, each signaling sending procedure corresponds to a sending time, or a default sending time may be used, or the time may be estimated based on network conditions such as signal conditions.

Step 533: If the coverage duration of the current network cannot support data transmission, and the UE needs to complete the data transmission based on a service requirement before losing coverage, the UE sends a request for increasing a transmission bandwidth (such as a satellite bandwidth) to a RAN, for example, the request for increasing the transmission bandwidth is triggered by a PDU session modification procedure, to ensure that the data transmission is completed before losing coverage.

Step 534: The RAN adjusts the bandwidth to increase the transmission bandwidth.

Step 535: The UE performs transmission based on the adjusted transmission bandwidth, and completes the data transmission before losing coverage.

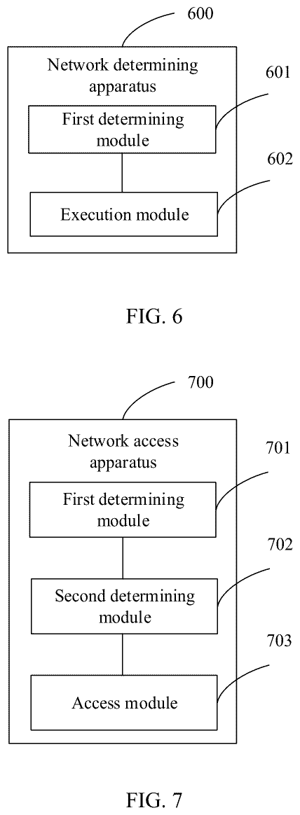

FIG. 6 shows a network determining apparatus provided in an embodiment of this application. The network determining apparatus 600 includes:

a first determining module 601, configured to determine coverage information of each of at least two networks, where the coverage information is used to indicate a time when the network covers a terminal; and

an execution module 602, configured to execute a first operation based on the coverage information, where the first operation includes at least one of the following:

selecting a first target network from the at least two networks; and

determining a priority of each of the at least two networks.

Further, the first determining module 601 includes:

an obtaining submodule, configured to obtain ephemeris information of each of the at least two networks; and

a determining submodule, configured to determine the coverage information of each of the at least two networks based on the ephemeris information of each of the at least two networks.

Further, the coverage information includes at least one of a coverage duration and a coverage time interval in which each of the at least two networks covers the terminal.

Further, the selecting a first target network from the at least two networks includes:

selecting a network with the longest coverage duration from the at least two networks as the first target network;

or

selecting a network with a highest matching degree between the coverage time interval and a service connection time of the terminal from the at least two networks as the first target network.

Further, the determining a priority of each of the at least two networks includes:

in a case that a coverage duration of a first network is longer than a coverage duration of a second network, determining that a priority of the first network is higher than a priority of the second network;

or

in a case that a matching degree between a coverage time interval of a first network and a service connection time of the terminal is higher than a matching degree between a coverage time interval of a second network and the service connection time of the terminal, determining that a priority of the first network is higher than a priority of the second network, where

the first network and the second network are any two of the at least two networks.

Further, the apparatus further includes:

a second determining module, configured to determine a first duration in which the first target network continues to cover the terminal; and

a third determining module, configured to determine, based on the first duration and an execution duration of a second operation, whether the terminal executes the second operation, where the second operation is an operation related to data transmission.

Further, the third determining module is configured to execute the second operation in a case that the first duration is longer than or equal to the execution duration of the second operation.

Further, the third determining module is configured to execute one of the following in a case that the first duration is shorter than the execution duration of the second operation:

buffering data related to the second operation;

suspending a procedure related to the second operation;

terminating the procedure related to the second operation; and

sending a first request for increasing a transmission bandwidth to a first target network device, where the first request carries the first duration.

Further, the second operation includes sending data or transmitting signaling.

Further, the apparatus further includes:

a transmission module, configured to transmit the data related to the second operation based on a target bandwidth, where the target bandwidth is a bandwidth determined based on the first request, and a time required for the terminal to transmit the data related to the second operation based on the target bandwidth is shorter than the first duration.

Further, the apparatus further includes:

a fourth determining module, configured to determine, in a case that the first target network does not cover the terminal, a first target time when the first target network covers the terminal again;

a fifth determining module, configured to determine a first access time based on the first target time; and

an access module, configured to access the first target network based on the first access time.

Further, the fifth determining module is configured to delay for a first preset time based on the first target time to obtain the first access time.

Further, the first preset time includes one of the following:

a random value;

a time interval value;

a value preconfigured in the terminal;

a value received by the terminal;

a value determined based on received signaling; and

a value obtained through calculation based on a terminal identity.

Further, the obtaining, by the terminal, ephemeris information of each of the at least two networks includes:

receiving, by the terminal, the ephemeris information sent by each of the at least two networks;

or

obtaining, by the terminal, the ephemeris information of each of the at least two networks locally.

Further, the ephemeris information includes at least one of the following:

satellite orbit information;

satellite location information; and

satellite speed information.

Further, the service connection time includes at least one of the following:

a time required by a network search process;

an active time of the terminal;

a time required for establishing a connection;

a time required for transmitting uplink data; and

a time required for transmitting downlink data.

The network determining apparatus provided in this embodiment of this application can implement each process implemented in the method embodiment in FIG. 2, with the same technical effects achieved. To avoid repetition, details are not described herein again.

FIG. 7 shows a network access apparatus provided in an embodiment of this application. The network access apparatus 700 includes:

a first determining module 701, configured to determine, in a case that a terminal is not covered by a second target network, a second target time when the second target network covers the terminal;

a second determining module 702, configured to determine a second access time based on the second target time; and

an access module 703, configured to access the second target network based on the second access time.

Further, the second determining module 702 is configured to delay for a second preset time based on the second target time to obtain the second access time.

Further, the second preset time includes one of the following:

a random value;

a time interval value;

a value preconfigured in the terminal;

a value received by the terminal;

a value determined based on received signaling; and

a value obtained through calculation based on a terminal identity.

The network access apparatus provided in this embodiment of this application can implement each process implemented in the method embodiment in FIG. 3, with the same technical effects achieved. To avoid repetition, details are not described herein again.

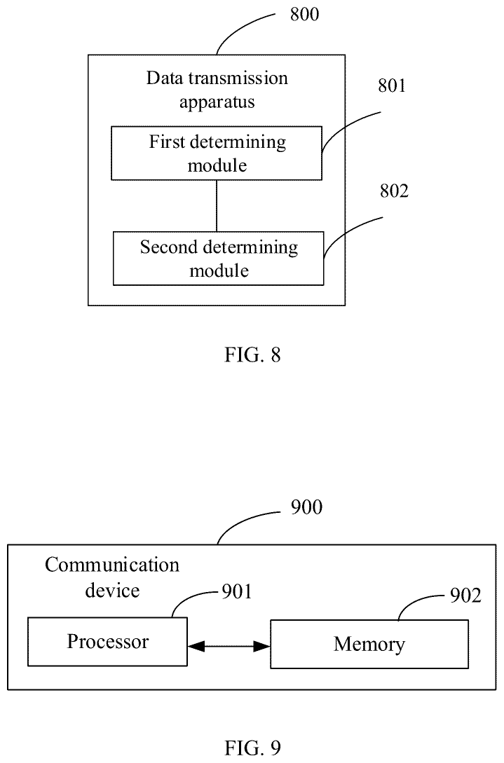

FIG. 8 shows a data transmission apparatus provided in an embodiment of this application. The data transmission apparatus 800 includes:

a first determining module 801, configured to determine, in a case that a network-side device is in a connected state with a terminal, a target duration in which a network of the network-side device continues to cover the terminal; and

a second determining module 802, configured to determine, based on the target duration and an execution duration of a target operation, whether the network-side device executes the target operation, where the target operation is an operation related to data transmission.

Further, the second determining module 802 is configured to:

execute the target operation in a case that the target duration is longer than or equal to the execution duration of the target operation.

Further, the second determining module 802 is configured to:

execute one of the following in a case that the target duration is shorter than the execution duration of the target operation:

buffering data related to the target operation;

suspending a procedure related to the target operation;

terminating the procedure related to the target operation;

sending a second request for increasing a transmission bandwidth to a first target network device, where the second request carries the target duration; and

adjusting a current transmission bandwidth of the network.

Further, the apparatus further includes a first transmission module, configured to transmit the data related to the target operation based on a first target bandwidth, where the first target bandwidth is a bandwidth determined based on the second request, and a time required for the network-side device to transmit the data related to the target operation based on the first target bandwidth is shorter than the target duration.

Further, the adjusting a current transmission bandwidth includes:

determining, by the network-side device based on a pre-obtained mapping relationship, a second target bandwidth corresponding to the target duration, where the mapping relationship includes a correspondence between duration and a bandwidth.

Further, the apparatus further includes a second transmission module, configured to transmit the data related to the target operation based on the second target bandwidth, where a time required for the network-side device to transmit the data related to the target operation based on the second target bandwidth is shorter than the target duration.

Further, the mapping relationship is configured by a second target network device.

Further, a parameter of the bandwidth in the mapping relationship includes at least one of the following:

an aggregate maximum bit rate AMBR;

an uplink UL maximum flow bit rate MFBR; and

a downlink DL MFBR.

Further, the target operation includes sending data or transmitting signaling.

Further, the first determining module 801 is configured to determine, based on ephemeris information of the network of the network-side device, the target duration in which the network continues to cover the terminal.

Further, the ephemeris information includes at least one of the following:

satellite orbit information;

satellite location information; and

satellite speed information.

The data transmission apparatus provided in this embodiment of this application can implement each process implemented in the method embodiment in FIG. 4, with the same technical effects achieved. To avoid repetition, details are not described herein again.

The apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a non-access stratum (NAS), and the like. This is not specifically limited in this embodiment of this application.

Optionally, as shown in FIG. 9, an embodiment of this application further provides a communication device 900, including a processor 901 and a memory 902. The memory 902 is configured to store a program or instructions capable of running on the processor 901. For example, when the communication device 900 is a terminal, and the program or instructions are executed by the processor 901, the steps of the foregoing method embodiment in FIG. 2 or FIG. 3 are implemented, with the same technical effects achieved. When the communication device 900 is a network-side device, and the program or instructions are executed by the processor 901, the steps of the foregoing method embodiment in FIG. 4 are implemented, with the same technical effects achieved. To avoid repetition, details are not described herein again.

An embodiment of this application further provides a terminal, including a processor and a communication interface. The processor is configured to: determine coverage information of each of at least two networks, where the coverage information is used to indicate a duration in which the network covers the terminal; and execute a first operation based on the coverage information, where the first operation includes at least one of the following: selecting a first target network from the at least two networks; and determining a priority of each of the at least two networks. The terminal embodiment corresponds to the foregoing terminal-side method embodiment in FIG. 2, and each implementation process and implementation of the foregoing method embodiment can be applied to the terminal embodiment, with the same technical effects achieved. Alternatively, the processor is configured to: in a case that the terminal is not covered by a second target network, determine a second target time when the second target network covers the terminal; determine a second access time based on the second target time; and access the second target network based on the second access time. The terminal embodiment corresponds to the foregoing terminal-side method embodiment in FIG. 3, and each implementation process and implementation of the foregoing method embodiment can be applied to the terminal embodiment, with the same technical effects achieved.

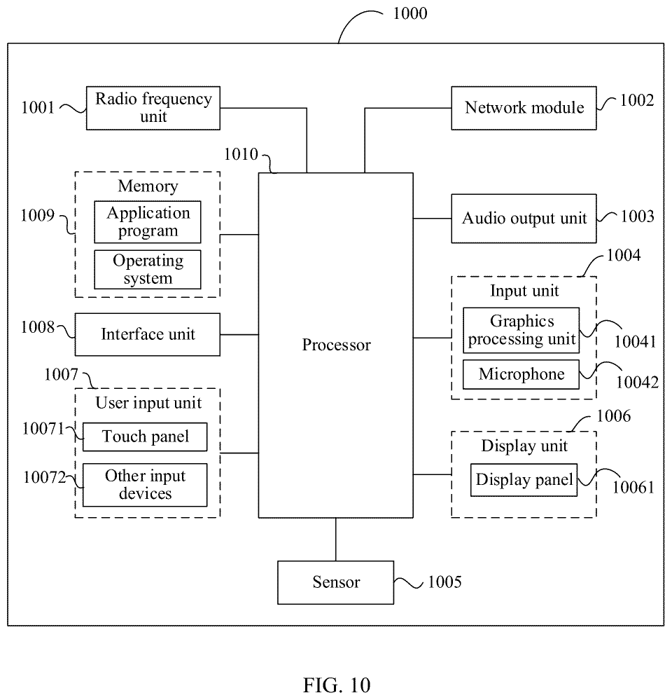

Specifically, FIG. 10 is a schematic diagram of a hardware structure of a terminal for implementing an embodiment of this application.

The terminal 1000 includes but is not limited to at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (for example, a battery) supplying power to all components. The power supply may be logically connected to the processor 1010 through a power management system. In this way, functions such as charge management, discharge management, and power consumption management are implemented by using the power management system. The terminal structure shown in FIG. 10 does not constitute a limitation on the terminal. The terminal may include more or fewer components than those shown in the figure, or some components are combined, or component arrangements are different. Details are not described herein again.

It should be understood that, in this embodiment of this application, the input unit 1004 may include a graphics processing unit (GPU) 10041 and a microphone 10042. The graphics processing unit 10041 processes image data of a still picture or video obtained by an image capture apparatus (such as a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1001 may transmit the downlink data to the processor 1010 for processing. In addition, the radio frequency unit 1001 may send uplink data to the network-side device. Usually, the radio frequency unit 1001 includes but is not limited to an antenna, an amplifier, a transceiver, a coupler, a low noise amplifier, a duplexer, and the like.

The memory 1009 may be configured to store software programs or instructions and various data. The memory 1009 may primarily include a first storage area for storing programs or instructions and a second storage area for storing data. The first storage area may store an operating system, an application program or instructions required by at least one function (such as an audio play function and an image play function), and the like. In addition, the memory 1009 may include a volatile memory or a non-volatile memory, or the memory 1009 may include both a volatile memory and a non-volatile memory. The non-volatile memory may be a read-only memory (ROM), a programmable read-only memory (PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synch Link DRAM, SLDRAM), and a direct rambus random access memory (Direct Rambus RAM, DRRAM). The memory 1009 in this embodiment of this application includes but is not limited to these and any other suitable types of memories.

The processor 1010 may include one or more processing units. Optionally, the processor 1010 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively be not integrated in the processor 1010.

The processor 1010 is configured to: determine coverage information of each of at least two networks, where the coverage information is used to indicate a duration in which the network covers the terminal; and execute a first operation based on the coverage information, where the first operation includes at least one of the following:

selecting a first target network from the at least two networks; and

determining a priority of each of the at least two networks.

Further, the processor 1010 is configured to: obtain ephemeris information of each of the at least two networks; and determine the coverage information of each of the at least two networks based on the ephemeris information of each of the at least two networks.

Further, the coverage information includes at least one of a coverage duration and a coverage time interval in which each of the at least two networks covers the terminal.

Further, the selecting a first target network from the at least two networks includes:

selecting a network with the longest coverage duration from the at least two networks as the first target network;

or

selecting a network with a highest matching degree between the coverage time interval and a service connection time of the terminal from the at least two networks as the first target network.

Further, the determining a priority of each of the at least two networks includes:

in a case that a coverage duration of a first network is longer than a coverage duration of a second network, determining that a priority of the first network is higher than a priority of the second network;

or

in a case that a matching degree between a coverage time interval of a first network and a service connection time of the terminal is higher than a matching degree between a coverage time interval of a second network and the service connection time of the terminal, determining that a priority of the first network is higher than a priority of the second network, where

the first network and the second network are any two of the at least two networks.

Further, the processor 1010 is configured to: determine a first duration in which the first target network continues to cover the terminal; and determine, based on the first duration and an execution duration of a second operation, whether the terminal executes the second operation, where the second operation is an operation related to data transmission.

Further, the processor 1010 is configured to execute the second operation in a case that the first duration is longer than or equal to the execution duration of the second operation.

Further, the processor 1010 is configured to execute one of the following in a case that the first duration is shorter than the execution duration of the second operation:

buffering data related to the second operation;

suspending a procedure related to the second operation;

terminating the procedure related to the second operation; and

sending a first request for increasing a transmission bandwidth to a first target network device, where the first request carries the first duration.

Further, the second operation includes sending data or transmitting signaling.

Further, the radio frequency unit 1001 is configured to transmit the data related to the second operation based on a target bandwidth, where the target bandwidth is a bandwidth determined based on the first request, and a time required for the terminal to transmit the data related to the second operation based on the target bandwidth is shorter than the first duration.

Further, the processor 1010 is configured to: in a case that the first target network does not cover the terminal, determine a first target time when the first target network covers the terminal again; determine a first access time based on the first target time; and access the first target network based on the first access time.

Further, the processor 1010 is configured to delay for a first preset time based on the first target time to obtain the first access time.

Further, the first preset time includes one of the following:

a random value;

a time interval value;

a value preconfigured in the terminal;

a value received by the terminal;

a value determined based on received signaling; and

a value obtained through calculation based on a terminal identity.

Further, the radio frequency unit 1001 is configured to receive the ephemeris information sent by each of the at least two networks;

or

the processor 1010 is configured to obtain the ephemeris information of each of the at least two networks locally.

Further, the ephemeris information includes at least one of the following:

satellite orbit information;

satellite location information; and

satellite speed information.

Further, the service connection time includes at least one of the following:

a time required by a network search process;

an active time of the terminal;

a time required for establishing a connection;

a time required for transmitting uplink data; and

a time required for transmitting downlink data.

The network determining apparatus provided in this embodiment of this application can implement each process implemented in the method embodiment in FIG. 2, with the same technical effects achieved. To avoid repetition, details are not described herein again.

In another aspect, the processor 1010 is configured to: in a case that the terminal is not covered by a second target network, determine a second target time when the second target network covers the terminal; determine a second access time based on the second target time; and access the second target network based on the second access time.

Further, the processor 1010 is configured to delay for a second preset time based on the second target time to obtain the second access time.

Further, the second preset time includes one of the following:

a random value;

a time interval value;

a value preconfigured in the terminal;

a value received by the terminal;

a value determined based on received signaling; and

a value obtained through calculation based on a terminal identity.

The terminal provided in this embodiment of this application can implement each process implemented by the method embodiment in FIG. 3, with the same technical effects achieved. To avoid repetition, details are not described herein again.

An embodiment of this application further provides a network-side device, including a processor and a communication interface. The processor is configured to: in a case that the network-side device is in a connected state with a terminal, determine a target duration in which a network of the network-side device continues to cover the terminal; and determine, based on the target duration and an execution duration of a target operation, whether the network-side device executes the target operation, where the target operation is an operation related to data transmission. The network-side device embodiment corresponds to the foregoing method embodiment of the network-side device, and each implementation process and implementation of the foregoing method embodiment can be applied to the network-side device embodiment, with the same technical effects achieved.

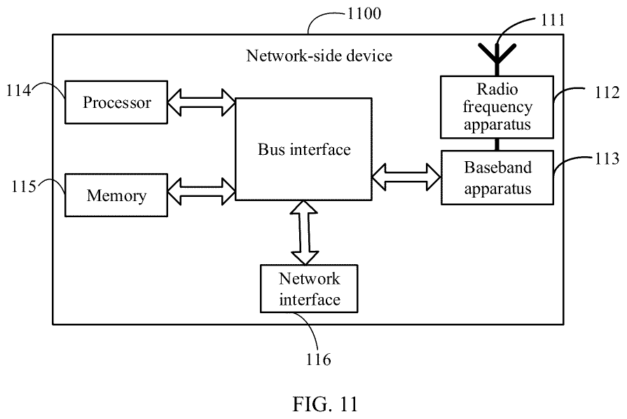

Specifically, an embodiment of this application further provides a network-side device. As shown in FIG. 11, the network-side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information by using the antenna 111, and sends the received information to the baseband apparatus 113 for processing. In a downlink direction, the baseband apparatus 113 processes to-be-sent information, and sends the information to the radio frequency apparatus 112; and the radio frequency apparatus 112 processes the received information and then sends the information out by using the antenna 111.

The method performed by the network-side device in the foregoing embodiment may be implemented in the baseband apparatus 113. The baseband apparatus 113 includes a baseband processor.

The baseband apparatus 113 may include, for example, at least one baseband unit, where a plurality of chips are disposed on the baseband unit. As shown in FIG. 11, one of the chips is, for example, the baseband processor, connected to the memory 115 by using a bus interface, to invoke a program in the memory 115 to perform the operation of the network-side device shown in the foregoing method embodiment.

The network-side device may further include a network interface 116, where the interface is, for example, a common public radio interface (CPRI).

Specifically, the network-side device 1100 in this embodiment of the present invention further includes a program or instructions stored in the memory 115 and capable of running on the processor 114. When the processor 114 invokes the program or instructions in the memory 115, the method performed by each module shown in FIG. 8 is performed, with the same technical effects achieved. To avoid repetition, details are not described herein again.

An embodiment of this application further provides a readable storage medium. where a program or instructions are stored in the readable storage medium, and when the program or instructions are executed by a processor, each process of the foregoing method embodiment shown in FIG. 2, FIG. 3, or FIG. 4 is implemented, with the same technical effects achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing method embodiment shown in FIG. 2, FIG. 3, or FIG. 4, with the same technical effects achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing method embodiment in FIG. 2, FIG. 3, or FIG. 4, with the same technical effects achieved. To avoid repetition, details are not described herein again.

An embodiment of this application further provides a communication system, including a terminal and a network-side device. The terminal may be configured to perform the steps of the foregoing method embodiment shown in FIG. 2 and/or the steps of the foregoing method embodiment shown in FIG. 3, and/or the network-side device may be configured to perform the steps of the foregoing method embodiment shown in FIG. 4.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. However, in most cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A network determining method, comprising:
determining, by a terminal, coverage information of each of at least two networks, wherein the coverage information is used to indicate a duration in which the network covers the terminal; and
executing, by the terminal, a first operation based on the coverage information, wherein the first operation comprises at least one of the following:
selecting a first target network from the at least two networks; and
determining a priority of each of the at least two networks.

2. The method according to claim 1, wherein the determining, by a terminal, coverage information of each of at least two networks comprises:
obtaining, by the terminal, ephemeris information of each of the at least two networks; and
determining, by the terminal, the coverage information of each of the at least two networks based on the ephemeris information of each of the at least two networks.

3. The method according to claim 1, wherein the coverage information comprises at least one of a coverage duration and a coverage time interval in which each of the at least two networks covers the terminal.

4. The method according to claim 3, wherein the selecting a first target network from the at least two networks comprises:
selecting a network with the longest coverage duration from the at least two networks as the first target network;
or,
selecting a network with a highest matching degree between the coverage time interval and a service connection time of the terminal from the at least two networks as the first target network;
or,
wherein the determining a priority of each of the at least two networks comprises:
in a case that a coverage duration of a first network is longer than a coverage duration of a second network, determining that a priority of the first network is higher than a priority of the second network;
or
in a case that a matching degree between a coverage time interval of a first network and a service connection time of the terminal is higher than a matching degree between a coverage time interval of a second network and the service connection time of the terminal, determining that a priority of the first network is higher than a priority of the second network, wherein
the first network and the second network are any two of the at least two networks;
wherein the service connection time comprises at least one of the following:
a time required by a network search process;
an active time of the terminal;
a time required for establishing a connection;
a time required for transmitting uplink data; and
a time required for transmitting downlink data.

5. The method according to claim 1, wherein after the selecting a first target network from the at least two networks, the method further comprises:
determining, by the terminal, a first duration in which the first target network continues to cover the terminal; and
determining, by the terminal based on the first duration and an execution duration of a second operation, whether the terminal executes the second operation, wherein the second operation is an operation related to data transmission;
or,
wherein after the selecting a first target network from the at least two networks, the method further comprises:
in a case that the first target network does not cover the terminal, determining, by the terminal, a first target time when the first target network covers the terminal again;
determining, by the terminal, a first access time based on the first target time; and
accessing, by the terminal, the first target network based on the first access time.

6. The method according to claim 5, wherein the determining, by the terminal based on the first duration and an execution duration of a second operation, whether the terminal executes the second operation comprises:
executing, by the terminal, the second operation in a case that the first duration is longer than or equal to the execution duration of the second operation;
or,
wherein the determining, by the terminal based on the first duration and an execution duration of a second operation, whether the terminal executes the second operation comprises:
executing, by the terminal, one of the following in a case that the first duration is shorter than the execution duration of the second operation:
buffering data related to the second operation;
suspending a procedure related to the second operation;
terminating the procedure related to the second operation; and
sending a first request for increasing a transmission bandwidth to a first target network device, wherein the first request carries the first duration;
or,
wherein the determining, by the terminal, a first access time based on the first target time comprises:
delaying, by the terminal, for a first preset time based on the first target time to obtain the first access time.

7. The method according to claim 6, wherein the second operation comprises sending data or transmitting signaling;
or,
wherein after the sending, by the terminal, a first request for increasing a transmission bandwidth to a first target network device, the method further comprises:
transmitting, by the terminal, the data related to the second operation based on a target bandwidth, wherein the target bandwidth is a bandwidth determined based on the first request, and a time required for the terminal to transmit the data related to the second operation based on the target bandwidth is shorter than the first duration.

8. The method according to claim 6, wherein the first preset time comprises one of the following:
a random value;
a time interval value;
a value preconfigured in the terminal;
a value received by the terminal;
a value determined based on received signaling; and
a value obtained through calculation based on a terminal identity.

9. The method according to claim 2, wherein obtaining, by the terminal, ephemeris information of each of at least two networks comprises:
receiving, by the terminal, the ephemeris information sent by each of the at least two networks;
or
obtaining, by the terminal, the ephemeris information of each of the at least two networks locally;
and/or,
wherein the ephemeris information comprises at least one of the following:
satellite orbit information;
satellite location information; and
satellite speed information.

10. A network access method, comprising:
in a case that a terminal is not covered by a second target network, determining, by the terminal, a second target time when the second target network covers the terminal;
determining, by the terminal, a second access time based on the second target time; and
accessing, by the terminal, the second target network based on the second access time.

11. The method according to claim 10, wherein the determining, by the terminal, a second access time based on the second target time comprises:
delaying, by the terminal, for a second preset time based on the second target time to obtain the second access time;
wherein the second preset time comprises one of the following:
a random value;
a time interval value;
a value preconfigured in the terminal;
a value received by the terminal;
a value determined based on received signaling; and
a value obtained through calculation based on a terminal identity.

12. A data transmission method, comprising:
in a case that a network-side device is in a connected state with a terminal, determining, by the network-side device, a target duration in which a network of the network-side device continues to cover the terminal; and
determining, by the network-side device based on the target duration and an execution duration of a target operation, whether the network-side device executes the target operation, wherein the target operation is an operation related to data transmission.

13. The method according to claim 12, wherein the determining, by the network-side device based on the target duration and an execution duration of a target operation, whether the network-side device executes the target operation comprises:
executing, by the network-side device, the target operation in a case that the target duration is longer than or equal to the execution duration of the target operation;
or,
wherein the determining, by the network-side device based on the target duration and an execution duration of a target operation, whether the network-side device executes the target operation comprises:
executing, by the network-side device, one of the following in a case that the target duration is shorter than the execution duration of the target operation:
buffering data related to the target operation;
suspending a procedure related to the target operation;
terminating the procedure related to the target operation;
sending a second request for increasing a transmission bandwidth to a first target network device, wherein the second request carries the target duration; and
adjusting a current transmission bandwidth of the network.

14. The method according to claim 13, wherein after the sending a second request for increasing a transmission bandwidth to a first target network device, the method further comprises:
transmitting, by the network-side device, the data related to the target operation based on a first target bandwidth, wherein the first target bandwidth is a bandwidth determined based on the second request, and a time required for the network-side device to transmit the data related to the target operation based on the first target bandwidth is shorter than the target duration;
or,
wherein the adjusting a current transmission bandwidth comprises:
determining, by the network-side device based on a pre-obtained mapping relationship, a second target bandwidth corresponding to the target duration, wherein the mapping relationship comprises a correspondence between duration and a bandwidth.

15. The method according to claim 14, wherein after the adjusting a current transmission bandwidth, the method further comprises:
transmitting, by the network-side device, the data related to the target operation based on the second target bandwidth, wherein a time required for the network-side device to transmit the data related to the target operation based on the second target bandwidth is shorter than the target duration.

16. The method according to claim 14, wherein the mapping relationship is configured by a second target network device;
or,
wherein a parameter of the bandwidth in the mapping relationship comprises at least one of the following:
an aggregate maximum bit rate AMBR;
an uplink UL maximum flow bit rate MFBR; and
a downlink DL MFBR.

17. The method according to claim 12, wherein the target operation comprises sending data or transmitting signaling.

18. The method according to claim 12, wherein the determining, by the network-side device, a target duration in which a network of the network-side device continues to cover the terminal comprises:
determining, by the network-side device based on ephemeris information of the network of the network-side device, the target duration in which the network continues to cover the terminal;
wherein the ephemeris information comprises at least one of the following:
satellite orbit information;
satellite location information; and
satellite speed information.

19. A terminal, comprising a processor and a memory, wherein the memory is configured to store a program or instructions capable of running on the processor; the program or instructions, when executed by the processor, causes the processor to perform: the steps of the network determining method according to claim 1.

20. A network-side device, comprising a processor and a memory, wherein the memory is configured to store a program or instructions capable of running on the processor, and when the program or instructions are executed by the processor, the steps of the data transmission method according to claim 12.
